(19) United States
(12) Patent Application Publication
(10) Pub. No.: US 2026/0347637 A1
(43) Pub. Date: Nov. 5, 2026

(54) METHOD AND COMPOSITION OF GRANULE COATING AND INTERCALATION

(71) Applicants: The United States of America, as represented by the Secretary of Agriculture, Washington, DC (US); TIDAL GROW AGRISCIENCE, BELLINGHAM, WA (US)

(72) Inventors: WILLIAM M. HART-COOPER, RICHMOND, CA (US); KAYDREN B. ORCUTT, ALBANY, CA (US); FRANKLIN Z. HUNG, CYPERESS, TX (US); SAMUEL N. KEMBALL-COOK, PACIFICA, CA (US); RAMESH RALIYA, FERNDALE, WA (US); YUAN CHENG, DAVIS, CA (US); JADON BLOUNT, BELLINGHAM, WA (US); JAMES SHOEMAKER, GILROY, CA (US); JONG HEON KIM, ALBANY, CA (US)

(21) Appl. No.: 19/553,484

(22) Filed: Mar. 2, 2026

Related U.S. Application Data
(60) Provisional application No. 63/769,304, filed on Mar. 10, 2025.

(51) Int. Cl. C09D 105/08; C05C 9/00; C05G 5/30; C09D 191/06

(52) U.S. Cl. CPC C09D 105/08; C05C 9/00; C05G 5/37; C05G 5/38; C09D 191/06

(57) ABSTRACT

Compositions for biodegradable granule coating and intercalation comprising a polysaccharide, a wax and an oil are described. The polysaccharide is exemplified by chitosan. The compositions can be used to coat fertilizer granules and improve the properties of granules such as active ingredient release profile, reducing dust off, anti-caking, and increasing water resistance.

This application claims the benefit of U.S. Provisional Application No. 63/769,304, titled “METHOD AND COMPOSITION OF GRANULE COATING AND INTERCALATION” filed Mar. 10, 2025, which is incorporated herein by reference in its entirety.

### BACKGROUND OF THE INVENTION

The agricultural industry faces significant challenges in maintaining fertilizer quality during storage, transportation, and application. Key quality control (QC) concerns include dust-off, caking, and moisture absorption, which can reduce the effectiveness of fertilizers and lead to complications during the handling and application processes. Additionally, the global population is projected to reach 10.4 billion by 2100 (UN), posing significant challenges for food security. To meet the increasing demand for food, it is essential to enhance crop yields sustainably without exacerbating environmental degradation. Traditional fertilizers often release nutrients at a rate faster than plants can uptake, leading to nutrient runoff and eutrophication of nearby aquatic environments (E. et al., 2024). This inefficiency results in wasted resources and environmental harm (Li et al., 2018). Enhanced efficiency fertilizers (EEF) have emerged as crucial innovations to address these issues. EEFs provide a controlled release of nutrients, improving nutrient use efficiency and reducing environmental impacts.

Most conventional fertilizer coatings are made from synthetic polymers (polyurethane or polyolefins), elemental sulfur, or waxes and oils due to their convenience and low cost; however, heavy uses of these compounds stress the environment and soil because of their lack of degradability and derivation from non-renewable sources. The United Nations Food and Agriculture Organization estimates that 100,000 metric tons of plastic enter the environment through plastic coated fertilizers yearly. Developing greener alternatives to these materials is critical to achieving sustainable agricultural practices.

Polymer-based coatings have an estimated market size of $1.22 billion in 2024 which is expected to reach $1.61 billion by 2029, representing significant growth opportunity for the development of more sustainable coatings (Mordor Intelligence, 2024).

The need exists for an effective fertilizer coating that can address many of the challenges uncoated fertilizers face such as dust off, caking, humidity absorbance, and premature release of nutrients. Moreover, it needs to be degradable in agricultural fields, yet still offer the many functional advantages over traditional polymer coated fertilizers that remain persistent in our soil.

### SUMMARY OF THE INVENTION

In one embodiment, compositions comprising a polysaccharide, a wax and an oil are described. In one embodiment, the composition is a coating or intercalated on a cube, pellet, granules or a tablet. In one embodiment, the composition is a coating on a fertilizer particle. In one embodiment, the fertilizer is urea. In a further embodiment, the composition is a cube, pellet, granules, tablet, or particle coated with a combination of a polysaccharide, a wax, and an oil.

In one embodiment of the composition, the polysaccharide is chitosan, the oil is castor oil, and the wax is stearic acid. In one embodiment, the ratio of chitosan (for example, in the form of 6% chitosan lactate in water), castor oil and stearic acid are in about 50:32:12 weight ratio respectively.

In one embodiment, a composition is described with at least one ionic polysaccharide, at least one nonionic biopolymer, a wax and an oil.

In one embodiment, a method of using a composition comprising a polysaccharide, a wax and an oil as coating or intercalated on a cube, pellet, granules, or tablet is described.

In various embodiments, methods of using a composition comprising a polysaccharide, a wax and an oil as coating or intercalated on a cube, pellet, granules, or tablet are described.

In one embodiment of the method, the composition is a coating on a fertilizer particle. In one embodiment of the composition, the fertilizer is urea. In one embodiment of the method, the composition is a coating wherein the polysaccharide is chitosan, the oil is castor oil, and the wax is stearic acid. In one embodiment, the ratio of chitosan (for example, 6% chitosan lactate in water), castor oil and stearic acid are in about 50:32:12 weight ratio respectively.

### BRIEF DESCRIPTION OF THE DRAWINGS

FIG. 1. shows a graphical map for sample and NaCl bath placement.

FIG. 2. shows the relationship between the different quality control measures. Dust-off represented by percent loss due to mechanical rubbing, anti-caking represented by the weight percent of sample that cakes together, and humidity resistance represented by the moisture percent weight gain (size of bubble). Controls-positive and negative-outlined in black. Lower values and smaller sizes indicate better performance.

FIG. 3. shows elements labeled over the SEM image: nitrogen (green), carbon (red), oxygen (blue). (a) SEM image of uncoated urea pellet surface with elements labeled over the SEM image. (b) Intensity of the elements for the uncoated pellet surface. (c) SEM image of urea pellets coated with 9.34% weight dry basis ratio of coating to urea pellet. (d) Intensity of the elements for coated pellet surface. (e) SEM image of cross-section of coated pellet (1.34% w/w dry basis ratio) labeled with elements. Coating is mostly carbon and thus labeled in red. Interior is mostly nitrogen and labeled with high intensity of green. (f) Intensity of elements in cross section of pellet.

FIG. 4. shows the time for the coated and uncoated urea pellets to dissolve in water after the application of bases and potential crosslinkers. Testing was done for these samples on 2 days, labeled as test 1 and test 2 in this figure. Both tests are included for the purpose of illustrating day to day variation.

FIG. 5. shows the effect of base treatment on persistence in water as measured by the time it takes the uncoated and coated pellets to dissolve.

FIG. 6. shows effect of crosslinkers on persistence in water as measured by the time it takes the coated and uncoated pellets to dissolve. The method of application of the crosslinker is via spray for these examples and is labeled with an(S) to indicate this method.

FIG. 7. shows the effect of crosslinkers on persistence in water as measured by the time it takes the uncoated and coated pellets to dissolve. The method of application of the crosslinker is via spray for these examples and is labeled with an(S) to indicate this method.

FIG. 8. shows the effect of method of application of crosslinkers on persistence in water as measured by the time it takes the coated and uncoated pellets to dissolve. Applying the crosslinker as a spray is indicated with an(S) in the figure, while mixing is indicated with an (M).

FIG. 9. shows the effect of addition of cellulose nanocrystals to increase persistence of coating in water as measured by the time it takes the coated pellets to dissolve. Cellulose nanocrystals were also tested in the formulation with the addition of crosslinkers.

FIG. 10. shows images of CH/CO/SA and CH/CO/SA/CNC coated pellets compared to commercial controls after 2 hours. The pellet coating without nanocellulose has started to dissolve in the water in this timeframe, while the pellets coated with the CH/CO/SA/CNC mixture remain intact, similar to the commercial control.

FIG. 11. shows images of the persistence of CH/CO/SA/CNC coated pellets over time at 0 hours, 2 hours, 20 hours, and 164 hours.

FIG. 12. shows persistence in water of CH/CO/SA/CNC coating as measured by the time it takes the coated pellets to dissolve. The CH/CO/SA formulation with and without cellulose addition was tested. The CO/SA/CNC formulation (with no chitosan) was also tested and showed very limited persistence in water. The longest measured timepoint in this experiment was 120 minutes, wherein both the CH/CO/SA and CH/CO/SA/CNC coated pellets remained intact. An additional image is included of the CH/CO/SA/CNC coated pellets after 2.5 months submerged in water to give a qualitative indication of the persistence of the coating in water over longer timeframes.

FIG. 13. shows marine degradation of CH/CO/SA-50:32:12 fertilizer coating for each replicate of the sample as well as the average. The error bars represent+/− one standard deviation. The single exponential fits for each replicate and the average are displayed as well.

FIG. 14. shows biodegradation of TO:ML:CH:CU-46:5:46:2 weight ratio coating formulation in home compost conditions at 25° C. Single exponential fit shown for full dataset as well as dataset truncated to 10 days.

### DETAILED DESCRIPTION

In one embodiment, compositions comprising one or more polysaccharides, one or more waxes and one or more oils are described.

In one embodiment, the composition comprises chitosan as a polysaccharide in the composition. In one embodiment, the polysaccharide in the composition is selected from one or more of cellulose, hemicellulose, starch, pectin, amylose, amylopectin, glycogen, inulin, agar, hyaluronic acid, alginate, dextran, carragennan, mannan, gum Arabic, guar gum, xanthan gum, chondroitin, chitin, or a chitosan derivative.

In one embodiment, one or more of the polysaccharides is a chitosan Schiff-base.

In one embodiment, one or more of the polysaccharides is a chitosan Schiff-base reductive amination product. In one embodiment, the one or more waxes in the composition is selected from capric acid, lauric acid, myristic acid, palmitic acid, polyhydroxy stearic acid, arachidic acid, glyceryl monocaprate, glyceryl monolaurate, glyceryl monomyristate, glyceryl monopalmitate, glyceryl monostearate, and combinations thereof.

In one embodiment, the one or more waxes in the composition are sourced from bees wax, carnauba wax, candelilla wax, shea butter, and combinations thereof.

In one embodiment, the one or more oils in the composition are selected from caprylic acid, palmitoleic acid, oleic acid, caproic acid, linoleic acid, linolenic acid, arachidonic acid, eicosapentaenoic acid, docosahexaenoic acid, and mixtures thereof.

In one embodiment, the one or more oils in the composition is selected from castor oil, tung oil, canola oil, corn oil, sesame oil, and/or mixtures thereof.

In one embodiment, the composition has an additional nonionic polysaccharide wherein said biopolymer is cellulose or derivative thereof, cellulose acetate, hydroxypropyl methylcellulose, carboxymethyl cellulose, methyl cellulose, ethyl cellulose, and mixtures thereof.

In one embodiment, the composition has an additional biopolyester or natural rubber containing polyisoprene, wherein said polyester is a polyhydroxyalkanoate, polyglycolic acid, polylactic acid, polybutylene succinate, polybutylene adipate terephthalate, polycaprolactone, and mixtures thereof.

In one embodiment, the composition is a coating on a granule wherein the coating thickness is approximately about 0.1 to 200 microns.

In one embodiment, the composition is a coating on a granule wherein the coating thickness is approximately about 20 to 130 microns. In one embodiment, the composition is a coating on a granule wherein the coating thickness is approximately about 40 to 60 microns. In one embodiment, the composition is a coating on a granule wherein the coating thickness is approximately about 50 microns.

In one embodiment, the composition is a coating on a granule wherein the weight ratio of coating to urea is about 0.1 to 10%. In one embodiment, the composition is a coating on a granule wherein the weight ratio of coating to urea is about 1.34% on a dry basis.

In one embodiment, the composition is a coating on a granule wherein the coated granules of a substance have a caking tendency between about 10-35%.

In one embodiment, the composition is a coating on a granule wherein the coated granules of a substance have a moisture gain of about 12% or less.

In one embodiment, the composition is a coating on a granule wherein the coated granules of a substance have a dust-off of about 1% or less.

In one embodiment, the composition is a coating, composite, or intercalated on a cube, pellet, granules or tablet.

In one embodiment, the coating has been treated with a neutralizing base, wherein the base is a sodium, potassium, calcium or magnesium carbonate, bicarbonate or hydroxide, e.g. sodium carbonate, potassium carbonate, calcium carbonate, magnesium carbonate, sodium bicarbonate, potassium bicarbonate, sodium hydroxide, potassium hydroxide, calcium hydroxide, magnesium hydroxide.

In one embodiment, the coating has been treated with a base applied as a solid powder to the coating.

In one embodiment, the coating has been treated with a base applied as a water-based solution.

In one embodiment of the composition, the polysaccharide is 6% chitosan lactate, the oil is castor oil, and the wax is stearic acid which are in about 50:32:12 weight ratio respectively. In one embodiment of the composition, the polysaccharide, oil is, and the wax are in weight ratio of about 40-60:about 20-40:about 2-22, respectively.

In one embodiment, the composition is a coating on a fertilizer particle.

In one embodiment of the composition, the fertilizer is urea, nitrate, ammonium, or ammonia.

In one embodiment of the composition, the chitosan used is chitosan acetate, chitosan lactate, chitosan malate, chitosan acetate low molecular weight, chitosan lactate low molecular weight, chitosan malate low molecular weight, chitosan acetate medium molecular weight, chitosan lactate medium molecular weight or chitosan malate medium molecular weight or mixtures thereof.

In one embodiment, the composition is a coating with an average biodegradation rate which corresponds to a half-life of 120 to 440 days.

In one embodiment, the composition is a coating wherein the average biodegradation rate is a first order rate constant of 3.67×10⁻³ days⁻¹ which corresponds to a calculated half-life of 280 days.

In one embodiment, the composition is a coating with an average biodegradation rate is a first order rate constant of 4.92E-3 days⁻¹ which corresponds to a half-life of 141 days.

In various embodiments, methods of using a composition comprising a polysaccharide, a wax and an oil as coating or intercalated on a cube, pellet, granules, or tablet are described.

In one embodiment, the polysaccharide is chitosan, which is chitosan acetate, chitosan lactate, chitosan malate, chitosan acetate low molecular weight, chitosan lactate low molecular weight, chitosan malate low molecular weight, chitosan acetate medium molecular weight, chitosan lactate medium molecular weight or chitosan malate medium molecular weight or mixtures thereof.

In one embodiment of the composition, the polysaccharide is chitosan, in combination with an oil and a wax. In one embodiment of the composition, the ratios of polysaccharide, oil and wax are in the ratios range from 1-97% polysaccharide: 1-97% oil: 1-97% wax for each component. In one embodiment of the composition, the ratios of polysaccharide, oil and wax are in the ratios range from 1-87% polysaccharide: 1-87% oil: 1-87% wax for each component. In one embodiment of the composition, the ratios of polysaccharide, oil and wax are in the ratios range from 1-77% polysaccharide: 1-77% oil: 1-77% wax for each component. In one embodiment of the composition, the ratios of polysaccharide, oil and wax are in the ratios range from 1-67% polysaccharide: 1-67% oil: 1-67% wax for each component. In one embodiment of the composition, the ratios of polysaccharide, oil and wax are in the ratios range from 1-37% polysaccharide: 1-37% oil: 1-37% wax for each component. In one embodiment of the composition, the polysaccharide is a mixture of chitosan and nanocellulose, an oil, and a wax. In one embodiment of the composition, the polysaccharides are chitosan and nanocellulose, the oil is castor oil, and the wax is stearic acid.

In one embodiment, the polysaccharide is chitosan, which is chitosan acetate, chitosan lactate, chitosan malate, chitosan acetate low molecular weight, chitosan lactate low molecular weight, chitosan malate low molecular weight, chitosan acetate medium molecular weight, chitosan lactate medium molecular weight or chitosan malate medium molecular weight or mixtures thereof.

In one embodiment, the polysaccharide is chitosan, the oil is castor oil, and the wax is stearic acid which are in about 50:32:12 weight ratio respectively.

In one embodiment, the granule is a fertilizer granule.

In one embodiment, the coated fertilizer granule coating is biodegradable with a half-life of 120 to 440 days.

In one embodiment, the coated fertilizer granule coating is biodegradable with a half-life of about 280 days.

The term “effective amount” of a composition, compound or property as provided herein means such amount as can perform the function of the compound or property for which an effective amount is expressed. As it is pointed out herein, the exact amount required will vary from process to process, depending on recognized variables such as the compounds employed, and various internal and external conditions observed as would be interpreted by one of ordinary skill in the art. Thus, it is not possible to specify an exact “effective amount,” though preferred ranges have been provided herein. An appropriate effective amount may be determined, however, by one of ordinary skills in the art using only routine experimentation.

The term “optional” or “optionally” means that the subsequently described event or circumstance may or may not occur or may not be sufficient and that the description includes instances in which said event or circumstance occurs and instances where it does not. For example, the phrase “optionally comprising a defoaming agent” means that the composition may or may not contain a defoaming agent and that this description includes compositions that contain and do not contain a foaming agent.

The term “substantially pure” refers to a composition that is at least about 90% (e.g., at least 90%) in purity by concentration (for e.g. weight/weight of a total composition). In a more preferred embodiment, the purity is at least about 95% (e.g., at least about 95%) weight-to-weight, or at least about 98% (e.g., at least about 98%) purity.

As used herein, the term “about” is defined as plus or minus ten percent of a recited value. For example, about 1.0 g means 0.9 g to 1.1 g.

The amounts, percentages, and ranges disclosed herein are not meant to be limiting, and increments between the recited amounts, percentages, and ranges are specifically envisioned as part of the invention.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicates otherwise.

It will be obvious to those skilled in the art that such embodiments are provided by way of example only. Numerous variations, changes, and substitutions will occur to those skilled in the art without departing from the embodiments of the claims. Various alternatives to the embodiments of the claims described herein may be employed in practicing the use of compositions and methods of treatment described herein. It is intended that the included claims define the scope of the various compositions and methods of treatment described herein and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

The term “consisting essentially of” excludes additional method (or process) steps or composition components that substantially interfere with the intended activity of the method (or process) or composition. This term may be substituted for inclusive terms such as “comprising” or “including” to more narrowly define any of the disclosed embodiments or combinations/sub-combinations thereof. Furthermore, the exclusive term “consisting of” is also understood to be substitutable for these inclusive terms.

The term coating used herein refers to a thin layer of material on core particles which modify their properties.

Polysaccharide refers to carbohydrates composed of long chains of monosaccharide units linked together.

Wax refers to any of numerous substances of plant or animal origin, soft lipophilic solids that are malleable near ambient temperatures exemplified by waxes of saturated fatty acids of about 10 to 20 carbon chain length range with a melting point temperature above 25° C. or glyceryl monoester thereof.

Oil refers to a viscous liquid derived from petroleum or biobased compositions exemplified by a saturated fatty acid of less than about 10 carbons or an unsaturated fatty acid with a carbon range of about 16 to 20 with a melting temperature below 25° C.

Chitosan refers to a linear polysaccharide composed of randomly distributed β-(1->4)-linked D-glucosamine (deacetylated unit) and N-acetyl-D-glucosamine (acetylated unit). It is made by treating the chitin with a base to hydrolyze acetyl residues. The term low molecular weight chitosan used herein refers to a chitosan polymer with a weight average molecular weight of less than 100 kDa. The term medium molecular weight chitosan used herein refers to a chitosan polymer with a weight average molecular weight of 100 to 310 kDa. Chitosan can form salts with acids exemplified herein by organic acids. Chitosan acetate is a water-soluble salt of chitosan and acetic acid. Chitosan lactate is a water-soluble salt of chitosan and lactic acid. Chitosan malate is a water-soluble salt of chitosan and malic acid.

Saturated fatty acid refers to a residue on a glyceride or a fatty acid which has chains that have all single bonds between the carbon atoms.

Glyceryl monoester is a mono ester of a fatty acid and glycerol.

The term natural sources used herein refers to materials, compounds, or substances that originate from living organisms and are not synthetically produced.

Beeswax is a natural wax secreted by honeybees (Apis genus).

Carnauba wax is a natural wax derived from the leaves of the carnauba palm (Copernicia prunifera).

Candelilla wax is a natural wax derived from the leaves of the candelilla shrub (Euphorbia antisyphilitica).

Shea butter is a fat extracted from the nut of the African shea tree (Vitellaria paradoxa).

The term composite used herein refers to a material system comprising two or more distinct constituent materials with significantly different physical or chemical properties.

The term intercalated used herein refers to a material structure wherein one or more guest species are reversibly inserted between the layers of a host material, without significantly altering the fundamental layered structure of the host.

A cube is a three-dimensional solid object bounded by six congruent faces with equal dimensions in length, width, and height.

A Pellet is a small, agglomerated particle, typically substantially spherical or cylindrical in shape, formed by compaction, extrusion, or granulation of powdered or finely divided material.

A Granule is a small, discrete particle or agglomerate of material, typically irregular or spherical in shape.

A Tablet is a solid particle of material, typically compressed, comprising one or more ingredients.

The term coated granules used herein refers to granules that have been enveloped with one or more layers of a distinct material.

Coating thickness is defined as the perpendicular distance between the outermost surface of an applied coating layer and the surface of the substrate to which it is applied.

Caking tendency is defined as the propensity of particulate or granular material to agglomerate and form coherent lumps under specified pressure, temperature, and humidity.

Caking percentage is a quantitative measure, expressed as a percentage, of the degree of agglomeration or lump formation within a particulate or granular material, determined by the proportion of material that fails to pass through a specified sieve after a standardized caking test.

Moisture gain is the increase in the mass of a substance due to the absorption or adsorption of water from its surrounding environment, expressed as a percentage of the initial dry mass.

Dust-off is the phenomenon wherein fine particulate matter detaches from the surface of a larger article, such as a granule or pellet, often due to mechanical abrasion, impact, or air currents.

A Fertilizer particle is a discrete unit of material comprising one or more plant nutrients, configured for application to soil or plants to enhance growth or yield.

Urea is an organic compound with the chemical formula CO(NH₂)₂, characterized as a white crystalline solid, highly soluble in water, and commonly employed as a nitrogen-releasing fertilizer.

The biodegradation rate is the speed at which a substance or material undergoes decomposition into simpler chemical compounds like carbon dioxide by the action of microorganisms and is calculated by applying a first order kinetics model.

Respirometry is the method by which the biodegradation rate is determined via quantification of CO₂ produced over time from the sample.

The half-life is the time required for the mass of a substance to reduce to half of its initial value, exemplified herein by use in the context of degradation.

A biopolyester is a polyester polymer that is either synthesized by living organisms or derived from biological sources.

The term natural rubber used herein refers to an elastomer derived from the latex of certain plants, predominantly comprising polyisoprene.

A nonionic polysaccharide is a polysaccharide that does not possess a net electrical charge under specified pH conditions.

The term derivative used herein refers to a chemical compound or substance that is obtained from another compound or substance by a chemical reaction.

The term biodegradable used herein refers to the ability of a substance or material to undergo decomposition into simpler chemical compounds by the action of living organisms found in soil, water, or composting facilities.

A neutralizing base is a chemical substance that reacts with an acid to form a salt and water, thereby reducing the acidity or increasing the pH of a solution or mixture.

Described below are some abbreviations used herein.
μg-microgram; μm-micrometer or micron.
mL-milliliter
w/w %-weight/weight percent concentration.
wt. %-weight percent concentration
Mw-molecular weight as the sum of the atomic weights of all atoms in a molecule kDa-kilodalton
Mn-statistical average molecular weight of all individual polymer chains in a sample, calculated by dividing the total weight of the sample by the total number of molecules
kg/cm²-force, with units of kilogram per centimeter squared RPM-rotations per minute

### Examples

Unless defined otherwise, all technical and scientific terms used herein have the same meaning as commonly understood by one of ordinary skill in the art to which the term belongs. Although any methods and materials similar or equivalent to those described herein can be used in the practice or testing of embodiments described, exemplified methods and materials are described which are included herein to further illustrate the embodiments and are not intended to limit the scope of the same as defined by the claims.

For the preparation of each coating, chitosan solution 6 wt. %, wax, and oil were combined at room temperature in a 50 mL glass beaker and heated to about 65° C. and mixed via magnetic stirrer. Exact amounts of each ingredient are detailed in Table 2. Once a homogeneous solution was formed, about 20 minutes, 2.00 w/w % coating was applied in its liquid form to triple sifted (0.078-0.111 in diameter) warmed lab grade urea granules at 55° C. The coated urea granules were allowed to dry at 55° C. oven for 1 hour before removing to equilibrate to room temperature. After cooling to room temperature, the pellets were quickly bagged inside resealable polyethylene zipper bags to prevent further moisture absorption or loss.

TABLE 1
Types of chitosan solution.

| Chitosan | wt. % | M_{w} | Mₙ | | wt. % | |
|---|---|---|---|---|---|---|
| Abbrev. * | Chitosan | (kDa) | (kDa) | Acid(s) | Acid | pH |
| CL-LMW | 6 | 95.8 | 55.3 | Lactic | 6 | — |
| (Batch 1) | | | | | | |
| CL-LMW | 6 | 91.8 | 58.3 | Lactic | 6 | 3.4 |
| (Batch 2) | | | | | | |
| CL-MMW | 6 | 201.1 | 88.7 | Lactic | 6 | 2.7 |
| CA-LMW | 6 | 91.8 | 58.3 | Acetic | 6 | 3.9 |
| CA-MMW | 6 | 201.1 | 88.7 | Acetic | 6 | 3.3 |
| CM-LMW | 6 | 91.8 | 58.3 | Malic, Acetic | 5.5, 0.5 | — |
| CM-MMW | 6 | 201.1 | 88.7 | Malic, Acetic | 5.5, 0.5 | — |

* CL = Chitosan Lactate, CA = Chitosan Acetate, CM = Chitosan Malate, LMW = Low Molecular Weight, MMW = Medium Molecular Weight

TABLE 2
Formulations of coatings.

| | CHITOSAN SOLUTION | | OIL | | WAX | |
|---|---|---|---|---|---|---|
| FORMULATION | ACID | MASS | | MASS | | MASS |
| NAME* | NAME | (g) | NAME | (g) | NAME | (g) |
| CH Only | Lactic | 10.00 | — | — | — | — |
| CO Only | Lactic | — | Castor | 10.00 | — | — |
| SA Only | Lactic | — | — | — | Stearic Acid | 10.00 |
| CH/CO - 100:32 | Lactic | 7.58 | Castor | 2.42 | — | — |
| CH/SA - 100:12 | Lactic | 8.93 | — | — | Stearic Acid | 1.07 |
| CO/SA - 32:12 | Lactic | — | Castor | 7.27 | Stearic Acid | 2.73 |
| Canola Oil + CH/MO | Lactic | 10.03 | Canola | 3.21 | Glyceryl | 1.22 |
| | | | | | monolaurate | |
| Corn Oil + CH/MO | Lactic | 10.00 | Corn | 3.21 | Glyceryl | 1.21 |
| | | | | | monolaurate | |
| Castor Oil + CH/MO | Lactic | 10.01 | Castor | 3.21 | Glyceryl | 1.20 |
| | | | | | monolaurate | |
| Sesame Oil + CH/MO | Lactic | 9.97 | Sesame | 3.20 | Glyceryl | 1.20 |
| | | | | | monolaurate | |
| Tung Oil + CH/MO | Lactic | 10.00 | Tung | 3.19 | Glyceryl | 1.20 |
| | | | | | monolaurate | |
| Stearic Acid + CH/CO | Lactic | 10.04 | Castor | 3.26 | Stearic Acid | 1.22 |
| Glyceryl Stearate + | Lactic | 10.01 | Castor | 3.29 | Glyceryl | 1.20 |
| CH/CO | | | | | Stearate** | |
| Myristic Acid + CH/CO | Lactic | 10.02 | Castor | 3.27 | Myristic Acid | 1.21 |
| Polyhydroxystearic | Lactic | 10.01 | Castor | 3.25 | Polyhydroxy- | 1.19 |
| Acid + CH/CO | | | | | stearic Acid | |
| Bees Wax + CH/CO | Lactic | 10.01 | Castor | 3.19 | Bees Wax | 1.19 |
| Carnauba + CH/CO | Lactic | 10.01 | Castor | 3.21 | Carnauba | 1.19 |
| Candelilla + CH/CO | Lactic | 10.00 | Castor | 3.21 | Candelilla | 1.18 |
| Oleic Acid + CH/CO | Lactic | 10.00 | Castor | 3.25 | Oleic Acid | 1.21 |
| Shea Butter + CH/CO | Lactic | 9.99 | Castor | 3.20 | Shea Butter | 1.21 |
| Lauric Acid + CH/CO | Lactic | 9.93 | Castor | 3.52 | Lauric Acid | 1.19 |
| CH/CO/SA - 100:32:6 | Lactic | 7.25 | Castor | 2.32 | Stearic Acid | 0.43 |
| CH/CO/SA - 100:32:12 | Lactic | 6.94 | Castor | 2.22 | Stearic Acid | 1.28 |
| CH/CO/SA - 100:32:24 | Lactic | 6.41 | Castor | 2.05 | Stearic Acid | 1.54 |
| CH/CO/SA - 100:16:12 | Lactic | 7.81 | Castor | 1.25 | Stearic Acid | 0.94 |
| CH/CO/SA - 100:64:12 | Lactic | 5.68 | Castor | 3.64 | Stearic Acid | 0.68 |
| CH/CO/SA - 50:32:12 | Lactic | 5.32 | Castor | 3.40 | Stearic Acid | 1.28 |
| CH/CO/SA - 200:32:12 | Lactic | 8.20 | Castor | 1.31 | Stearic Acid | 0.49 |
| CA-LMW + CO/SA | Acetic | 5.33 | Castor | 3.40 | Stearic Acid | 1.28 |
| CA-MMW + CO/SA | Acetic | 5.33 | Castor | 3.41 | Stearic Acid | 1.28 |
| CL-LMW + CO/SA | Lactic | 5.33 | Castor | 3.40 | Stearic Acid | 1.28 |
| CL-MMW + CO/SA | Lactic | 5.32 | Castor | 3.40 | Stearic Acid | 1.28 |
| CM-LMW + CO/SA | Malic, Acetic | 5.32 | Castor | 3.41 | Stearic Acid | 1.28 |
| CM-MMW + CO/SA | Malic, Acetic | 5.32 | Castor | 3.40 | Stearic Acid | 1.28 |

*CH = CL-LMW (Batch 1), CO = Castor Oil, SA = Stearic Acid. For information on CA-LMW, CA-MMW, CL-LMW, CL-MMW, CM-LMW, or CM-MMW, see Table 1.
**SE = Self Emulsifying, contains 1-3% sodium stearate)

### Methods for Testing

### Caking.

The following caking test was adapted from the International Fertilizer Development Center (IFDC)'s Manual for Determining Physical Properties of Fertilizer, 1986 “Caking tendency (Small-Bag Method)” for quick laboratory scale testing incorporated herein by reference in its entirety.

All samples for testing should be triple screened with sieves to be between 0.078-0.111 inches in diameter. Place a 1.5″×1.5″ clear resealable poly bag (obtained from Amazon Co., brand iMBAPrice) on a needle board with 6 needles/cm². Extra care should be exercised to ensure each bag used is the same length used across all test samples. Using a rubber hammer, gently tap the surface of the bag until incisions are made through both layers of the bag. Pour 7.00±0.01 g of sample into each bag. Place the bags inside 100% RH for 24-36 hours at 25° C.

Remove the samples from the humidity chamber and place a rigid plastic barrier between the top and bottom of the sample bags. Evenly distribute weights on the top clipboard until a pressure of 0.25 kg/cm² is on the sample bags. Set the oven to 40-55° C. for 24-48 hours. Remove weights and samples from the oven. Allow the samples to equilibrate to room temperature for 30 minutes.

Mount a USA Standard Testing sieve collection pan on a laboratory shaker. Place a USA Standard Testing Sieve #7, 2.730 mm (Gilson Company) on the collection pan. Open a sample bag, using a razor blade when necessary. Extreme caution should be exercised to avoid prematurely breaking the pellets. Carefully place the removed sample on top of the sieve. Allow the shaker to run for 1 minute at 300 rpm.

Record the mass of sample that did not make it through the sieve (m_{not screened}). Remove the sieve and record the mass of the sample that made it through the sieve (m_{screened}). Calculate the caking percentage according to the following formula:

$$Caking Percentage = \frac{{m}_{not screened}}{{m}_{not screened} + {m}_{s c r e e n e d}} * 100$$

Dust off.

The following dust off test was adapted from the International Fertilizer Development Center (IFDC)'s Manual for Determining Physical Properties of Fertilizer, 1986 “Abrasion Resistance (Rotary-Drum Method)” for quick laboratory scale testing incorporated herein by reference in its entirety.

All samples for testing should be triple screened with sieves to be between 0.078-0.111 inches in diameter. Place a 5 cm, 12.10 g stir bar into a 50 mL Falcon tube. Pour 7.00±0.01 g of test sample into the Falcon tube. Realign the weight so it is in the center of the Falcon tube. Secure the Falcon tube to a vortex (Scientific Industries Vortex-Genie® 2) using laboratory tape. Laboratory tape is used to secure the Falcon tube to the vortex instead of holding the tube to the vortex to minimize error introduced by vibration absorption by the hand. Run the vortex at maximum power for 90 seconds.

Mount a USA Standard Testing sieve collection pan on a laboratory shaker. Place a USA Standard Testing Sieve #10, 0.078 in (The Tyler Standard Screen Scale) on the collection pan. Pour the Falcon tube's contents through the sieve and turn on the laboratory shaker to 300 rpm for 1 minute. Record the mass of sample that did not make it through the sieve (m_{not screened}). Calculate the dust-off percentage according to the following formula:

$$Dust Off Percentage = \frac{{m}_{not screened}}{7.00} * 100$$

### Humidity.

Humidity testing was based on water weight gain in a humidity chamber. To ensure that the water gain was controlled, a salt solution (6M NaCl) was employed to keep the chamber at a set humidity. This method is well-known in the biofilm industry.

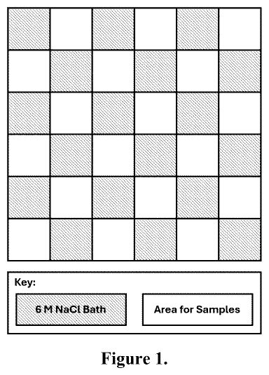

All samples for testing should be triple screened with sieves to be between 0.078-0.111 inches in diameter. Using an analytical balance, record the mass of a 1.5″×2.0″ weigh boat (m_{weigh boat}). Tare and weigh 1000.0±25.0 mg sample (mₛₐₘₚₗₑ). Using 3.4″×3.4″ weigh boats, create a chessboard pattern according to FIG. 1. Pour 6 mL 6 M NaCl solution into each 3.4″×3.4″ weight boat. Arrange test samples in the unoccupied locations. Allow samples to remain inside the humidity chamber at 25° C. for 8-10 days.

Record the mass of the weigh boat and sample (m_{X days}). Calculate the water gain percentage according to the following formula:

$$Water Gain Percentage = \frac{{m}_{X days} - {m}_{Weigh boat}}{{m}_{sample}} * 100$$

### Characterization of Coatings.

The effectiveness of each coating was evaluated based on three criteria:caking percentage, dust off, and moisture gain. As shown in Table 3, the performance of the fertilizer coating can be adjusted based on the oil used. These properties can further be adjusted by varying the wax used, as shown in Table 4.

### Formulation.

The initial formulation contains 3 parts: chitosan lactate, an oil, and a wax. Testing supports chitosan lactate's role in reducing dust off and caking when added in the optimal ratio. Waxes contributed to an overall decrease in dust off, while oils decreased dust off and moisture gain. Different oils and waxes were screened for compatibility in the formulation as well as their ability to limit caking, dust-off, and moisture gain, using the methods listed above.

### Testing Chitosan Molecular Weight and Acid.

Chitosan of different molecular weights and with different acids (see Table 1 for composition information) were used in a 6% chitosan solution: castor oil: stearic acid weight ratio of 50:32:12. The values are reported relative to the best performer of each category in Table 3. For example, the medium molecular weight chitosan acetate (CA-MMW) had the best caking value, so the other values are relative to that value.

TABLE 3
Relative comparison of chitosan molecular weight and acid,
values relative to best performing entry in each column

| | CAKING** | DUST OFF | MOISTURE |
|---|---|---|---|
| COMPOSITION* | (relative %) | (relative %) | GAIN***(relative %) |
| CA-LMW + CO/SA | 1.7 | 1.9 | 1.2 |
| CA-MMW + CO/SA | 1.0 | 2.4 | 1.1 |
| CL-LMW (Batch 2) + CO/SA | 1.9 | 1.1 | 1.3 |
| CL-MMW + CO/SA | 2.0 | 1.0 | 1.0 |
| CM-LMW + CO/SA | 1.9 | 1.7 | 1.2 |
| CM-MMW + CO/SA | 1.8 | 2.3 | 1.0 |

*Formulation ratio by weight, Chitosan Solution:Castor Oil:Stearic Acid, 50:32:12. All chitosan solutions are 6 wt. % chitosan. See table 1 for detailed information on chitosan solutions.
**Caking tendency testing was performed at 25 °C @ 100% RH for 32.87 hours, then 55 °C @ 0% RH for 46.68 hours with 0.25 kg/cm² of force.
***Moisture gain testing was performed at 75% RH for 120.30 hours at 25 °C.
****Lowest value for caking, dust off, moisture gain

Medium molecular weight chitosan acetate had the best anti-caking properties, with all other values being twice as bad. The chitosan lactate samples (both low molecular weight and medium molecular weight) show the best dust-off performance, with the other being 1.7 to 2.4 times worse. The moisture gain values are not significantly different (1.0 vs 1.3 times difference).

### Testing Different Oils.

The effects of different oils in the formulation were tested by holding the weight ratios of the oil, wax, and chitosan lactate constant. Glyceryl monolaurate was used as the wax in all formulations while the oils were being tested. In all cases, uncoated laboratory grade urea granules were used as the negative controls to study the relative impact of each coating formulation.

The initial wax and oil screening process for each test was run with an estimated error of caking=±25%, dust off=±1.5%, moisture gain=±1.5%. Errors were based on the maximum error ovserved from uncoated controls run in triplicate.

As shown in Table 4, castor oil had the best performance during dust off testing at 1.00±1.5% which is significantly better than all other tested oils (ranging from 4.43% to 18.52%). No significant differences were observed in caking testing. Little differences were observed during humidity testing. Due to castor oil's performance and status as a non-food oil, further optimization testing was performed by testing different waxes.

TABLE 4
Screening of Various Oils

| | CAKING** | DUST OFF | MOISTURE |
|---|---|---|---|
| COMPOSITION* | (%) | (%) | GAIN*** (%) |
| Lab Urea | 79.73 | 18.52 | 8.87 |
| Canola Oil + CH/MO | 93.55 | 6.00 | 8.78 |
| Corn Oil + CH/MO | 95.29 | 6.71 | 9.57 |
| Castor Oil + CH/MO | 99.57 | 1.00 | 10.54 |
| Sesame Oil + CH/MO | 97.28 | 5.86 | 9.64 |
| Tung Oil + CH/MO | 99.42 | 4.43 | 8.48 |

*CH = CL-LMW (Batch 1), MO = Glycerol Monolaurate. Formulation ratio by weight, Oil:CH:MO, 32:100:12
**Caking tendency testing was performed at 25 °C @ 100% RH for 20.98 hours, then 40 °C @ 0% RH for 18.45 hours with 0.05 kg/cm² of force.
***Moisture gain testing was performed at 75% RH for 146.10 hours at 25 °C.

### Testing Different Waxes.

The effect of different waxes on the performance of the coatings was determined by holding the weight ratios of chitosan lactate, castor oil, and wax component constant, while swapping the tested wax in question. The results are shown in Table 5.

Stearic acid was identified to have decreased caking the most. No significant differences were observed in dust off or humidity testing. Stearic Acid+CH/CO was identified to be the best formulation ingredient combination. Further testing was conducted on the winning formulation through ratio testing.

TABLE 5
Screening of Various Waxes

| | CAKING** | DUST OFF | MOISTURE GAIN*** |
|---|---|---|---|
| COMPOSITION* | (%) | (%) | (%) |
| Stearic Acid + CH/CO | 8.14 | 0.29 | 11.03 |
| Glyceryl Stearate + CH/CO | 34.58 | 0.43 | 11.42 |
| Myristic Acid + CH/CO | 55.48 | 0.00 | 7.84 |
| Polyhydroxystearic Acid + CH/CO | 86.96 | 0.57 | 9.67 |
| Bees Wax + CH/CO | 89.86 | 0.00 | 9.51 |
| Lab Urea | 79.73 | 18.52 | 8.87 |
| Carnauba + CH/CO | 95.27 | 0.86 | 8.52 |
| Candelilla + CH/CO | 96.02 | 1.00 | 7.82 |
| Oleic Acid + CH/CO | 96.83 | 1.14 | 10.63 |
| Shea Butter + CH/CO | 97.56 | 1.71 | 11.11 |
| Lauric Acid + CH/CO | 98.57 | 2.86 | 8.47 |
| Glyceryl monolaurate + CH/CO | 99.57 | 1.00 | 10.54 |

*CH = CL-LMW (Batch 1), CO = Castor Oil. Formulation ratio by weight, Wax:CH:CO, 12:100:32
**Caking tendency testing was performed at 25 °C @ 100% RH for 20.98 hours, then 40 °C @ 0% RH for 18.45 hours with 0.05 kg/cm² of force.
***Moisture gain testing was performed at 75% RH for 146.10 hours at 25 °C.

### Testing Ingredient Ratios.

The effect of different ratios between ingredients in the winning Stearic Acid+CH/CO formulation were tested by holding the weight ratios of two of three components constant while changing the mass of the third component. The mass of the third component was doubled and then halved (ex. for the wax, it was 3 g vs 1.5 g vs 6 g). The results are shown in Table 6.

TABLE 6
Effect of Chitosan in Formulation

| | CAKING** | DUST OFF | MOISTURE |
|---|---|---|---|
| COMPOSITION* | (%) | (%) | GAIN*** (%) |
| CH Only | 100.00 ± 0.00 | 7.76 ± 2.73 | 8.06 ± 0.96 |
| CO/SA - 32:12 | 54.34 ± 27.10 | 12.95 ± 5.53 | 6.06 ± 1.14 |
| CH/CO/SA - 50:32:12 | 30.82 ± 15.16 | 0.29 ± 0.14 | 6.09 ± 1.19 |
| CH/CO/SA - 100:32:12 | 93.45 ± 7.19 | 8.90 ± 7.20 | 7.52 ± 0.47 |
| CH/CO/SA - 200:32:12 | 80.82 ± 20.99 | 7.90 ± 0.36 | 6.96 ± 2.18 |

*CH = CL-LMW (Batch 1), CO = Castor Oil, SA = Stearic Acid. Formulation ratios are by weight.
**Caking tendency testing was performed at 25 °C @ 100% RH for 36 hours, then 55 °C @ 0% RH for 48 hours with 0.25 kg/cm² of force.
***Moisture gain testing was performed at 75% RH for 92.02 hours at 25 °C.

The formation without chitosan showed a caking of 54%, with a dust-off of 13% and a moisture weight percent gain of 6%. The addition of chitosan saw a 1.7× reduction in caking, a 45× reduction in dust off, and no significant change to the moisture weight gain. Increasing the amount of chitosan in the formulation beyond the initial ratio (50:32:12), saw the caking triple, the dust-off increase by 30×. The humidity did not change significantly. Based on these results, adding chitosan to the oil/wax formulation improves caking and dust-off without affecting moisture resistance, but adding too much chitosan worsens caking and dust-off.

TABLE 7
Effect of Castor Oil in Formulation

| | CAKING** | DUST OFF | MOISTURE |
|---|---|---|---|
| COMPOSITION* | (%) | (%) | GAIN*** (%) |
| CO Only | 85.61 ± 9.10 | 5.48 ± 1.90 | 4.91 ± 0.36 |
| CH/SA - 100:12 | 99.57 ± 0.52 | 31.00 ± 3.67 | 7.67 ± 1.48 |
| CH/CO/SA - 100:16:12 | 91.89 ± 7.97 | 20.29 ± 4.83 | 5.38 ± 0.27 |
| CH/CO/SA - 100:32:12 | 93.45 ± 7.19 | 8.90 ± 7.20 | 7.52 ± 0.47 |
| CH/CO/SA - 100:64:12 | 95.99 ± 4.47 | 0.62 ± 0.50 | 7.25 ± 0.83 |

*CH = CL-LMW (Batch 1), CO = Castor Oil, SA = Stearic Acid. Formulation ratios are by weight.
**Caking tendency testing was performed at 25 °C @ 100% RH for 36 hours, then 55 °C @ 0% RH for 48 hours with 0.25 kg/cm² of force.
***Moisture gain testing was performed at 75% RH for 92.02 hours at 25 °C.

Adding castor oil to the chitosan/stearic acid formulation decreases dust off by 1.5×, decreases caking by 1.1×, and decreases water gain by 1.4×, as shown in Table 7. Doubling the weight ratio of castor oil improves the dust off by 2.3× but quadrupling the weight ratio of castor oil improves the dust off by 33×. The caking and moisture gain do not change significantly by increasing castor oil (Table 7).

TABLE 8
Effect of Stearic acid in Formulation

| | CAKING** | DUST OFF | MOISTURE |
|---|---|---|---|
| COMPOSITION* | (%) | (%) | GAIN*** (%) |
| SA Only | 96.14 ± 1.82 | 30.19 ± 1.01 | 6.32 ± 1.54 |
| CH/CO - 100:32 | 99.57 ± 0.43 | 1.14 ± 0.57 | 7.28 ± 0.91 |
| CH/CO/SA - 100:32:6 | 90.25 ± 8.52 | 0.48 ± 0.22 | 6.21 ± 1.38 |
| CH/CO/SA - 100:32:12 | 93.45 ± 7.19 | 8.90 ± 7.20 | 7.52 ± 0.47 |
| CH/CO/SA - 100:32:24 | 66.96 ± 23.01 | 18.52 ± 3.26 | 7.05 ± 0.66 |

*CH = CL-LMW (Batch 1), CO = Castor Oil, SA = Stearic Acid. Formulation ratios are by weight.
**Caking tendency testing was performed at 25 °C @ 100% RH for 36 hours, then 55 °C @ 0% RH for 48 hours with 0.25 kg/cm² of force.
***Moisture gain testing was performed at 75% RH for 92.02 hours at 25 °C.

Adding stearic acid to the chitosan/castor oil formulation improves caking by 1.1×, dust-off by 2.4× and moisture weight gain by 1.2×(See CH/CO/SA-100:32:6). Increasing the stearic acid proportion further leads to significantly worse dust off and moisture weight gain, as shown in Table 8.

Upon analysis of all ratio tests, it was determined that a 50:32:12 ratio between chitosan lactate solution, castor oil, and stearic acid performs the best.

It's important to note that none of the single component formulations performed well in an individual manner. Synergies were identified between chitosan lactate and castor oil in reducing dust off from 7.76% and 5.48% respectively when tested alone, to 1.14% when mixed together.

Various positive and negative control fertilizers were evaluated as a baseline comparison metric. Uncoated urea pellets were used as a negative control. Two coated urea fertilizers were used as positive controls (labeled positive control 1 and positive control 2). The results of each control are outlined in Table 9.

TABLE 9
Performance of Positive and Negative Controls

| | CAKING** | DUST OFF | MOISTURE |
|---|---|---|---|
| COMPOSITION | (%) | (%) | GAIN*** (%) |
| Negative Control* | 89.38 ± 2.62 | 19.95 ± 3.14 | 5.67 ± 0.22 |
| Positive Control 1 | 99.95 ± 0.09 | 0.95 ± 0.44 | 21.25 ± 0.84 |
| Positive Control 2 | 92.64 ± 5.52 | 0.24 ± 0.08 | 11.12 ± 1.14 |

*Uncoated urea pellets
**Caking tendency testing was performed at 25 °C @ 100% RH for 36 hours, then 55 °C @ 0% RH for 48 hours with 0.25 kg/cm² of force.
***Moisture gain testing was performed at 75% RH for 92.02 hours at 25 °C.

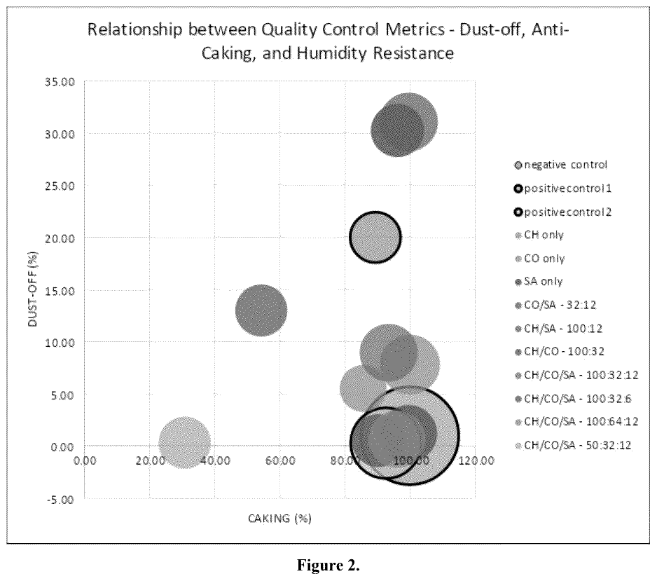

FIG. 2 illustrates the performance of each formulation across all three parameters-dust-off, anti-caking, and humidity resistance. Smaller values indicate better performance. The size of the data point is representative of the moisture weight gain value. Note that for most of the formulations, the moisture gain values are indistinguishable. The exceptions are the two positive controls which have higher moisture retention of 21% and 11% respectively. The positive controls perform better than the negative control for dust-off but perform worse in humidity resistance and do not significantly differ in anti-caking. The stearic acid only and chitosan/stearic acid coated samples are worse than the negative control in dust off and are not significantly different in caking or moisture retention. The chitosan/castor oil coating shows better anti-caking, and shows a small improvement in dust-off, with no difference in moisture retention. The chitosan/castor oil/stearic acid formulation at 50:32:12 weight ratio shows the best overall characteristics with a significant performance enhancement in anti-caking and dust-off compared to the negative controls, and a significant improvement in humidity resistance and anti-caking compared to the positive controls.

### Proof of Coating Via Elemental Analysis on Scanning Electron Microscope

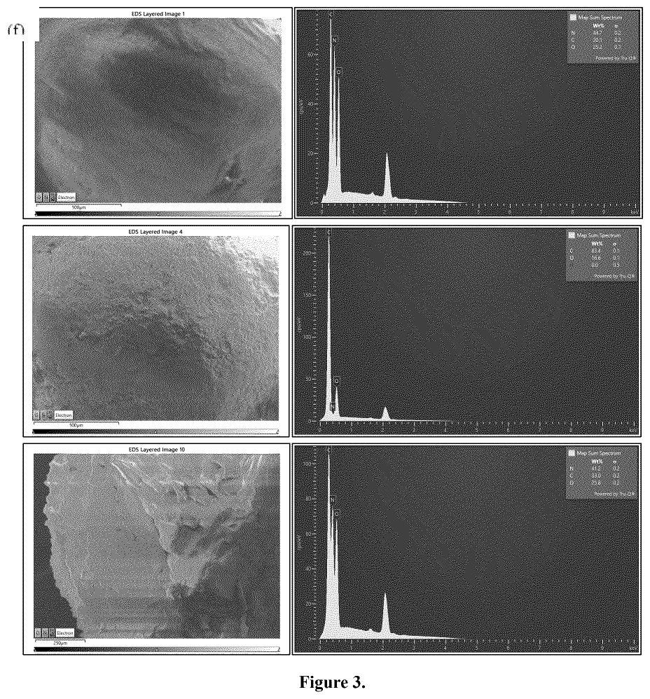

Negative control shows 45 wt. % nitrogen at the surface, as well as a 29 wt. % carbon and 26 wt. % oxygen (FIG. 3a, 3b). As urea is 46% by weight of nitrogen, the method is verified.

For the coated samples, the nitrogen at the surface is significantly reduced-appearing as 0.0%, though there is a high associated error due to how close the signal is for the carbon and oxygen (FIG. 3c). Carbon now makes up most of the surface at 83.4 weight % (FIG. 3d). The coating should only have ~1 weight % nitrogen, so the lack of nitrogen proves that the pellet was successfully coated. The even distribution of color across the image also indicates an even coating as there are not nitrogen rich gaps in the coating in the image.

The cross section of the coating shows two distinct regions: the edge, which is nitrogen-deficient and the interior, which is nitrogen rich (green) (FIG. 3e). This proves the coating is not penetrating very deep into the surface. The thickness of the coating can also be determined via this method; the thickness is approximately 50 microns for a 1.34% weight ratio of coating to urea.

### Active Ingredient Release Profile

Three or four component formulas (chitosan, wax, oil, crosslinker or base) can be used to alter the release pattern of the fertilizer. For urea pellets, the urea can be tracked via refractometry or visual inspection based on when the pellets fully dissolve.

Water persistence was determined by the time it took for the coated pellets to dissolve in water. The urea is very water soluble, so if the coating has dissolved, then the urea has also dissolved at that point. Short and long time points were taken to understand the persistence on the scale of hours to months.

Refractometry was used to determine the concentration of urea in water to find the release time from the pellets. An analog refractometer (aichose brand Deisel Exhaust Fluid Refractometer) was used, with a working range of 0 to 40% urea concentration in water to determine the concentration of urea that had leached out from the pellets. Procedure for using the refractometer to measure urea was adapted from Bhati & Raliya Comparative estimation of nitrogen in urea and its derivative products using TKN, CHNS and hand-held refractometer. Sci Rep 12, 11704 (2022) incorporated by reference herein in its entirety. First, a calibration curve is created with urea in water by placing 3 drops of liquid on the sample port and measuring the value seen through the eye piece. The samples of interest are measured, and the calibration curve is used to calculate the urea concentration.

Treating Coated Pellets with Base

Pellets were coated with ~1% (weight ratio of dry coating to urea pellet) of the chitosan lactate (55 kDa, 6% in water). While still wet, the pellets were coated with 1.5 molar equivalents of base. For ease of coating, the base was dissolved in the minimum amount of water. Pellets were tested by placing in water and visually inspected to see if they had dissolved. Once the pellet was dissolved, the urea would also have to be released. Likely the release is occurring before the pellet has visually dissolved in the water.

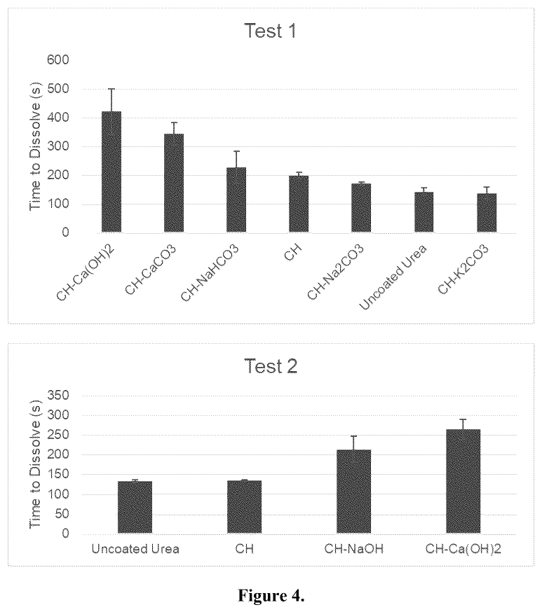

FIG. 4 shows the time for the coated and uncoated urea pellets to dissolve in water after the application of bases and potential crosslinkers. Calcium hydroxide [Ca(OH)₂], Calcium carbonate [Ca(CO₃)], and sodium hydroxide (NaOH) showed significant slowing of the release rate of the urea (FIG. 4). Testing was done on two separate days, indicated by number in the chart title. While this does show the day-to-day variability, the specified bases still had a significant impact compared to the pellets coated with chitosan lactate alone.

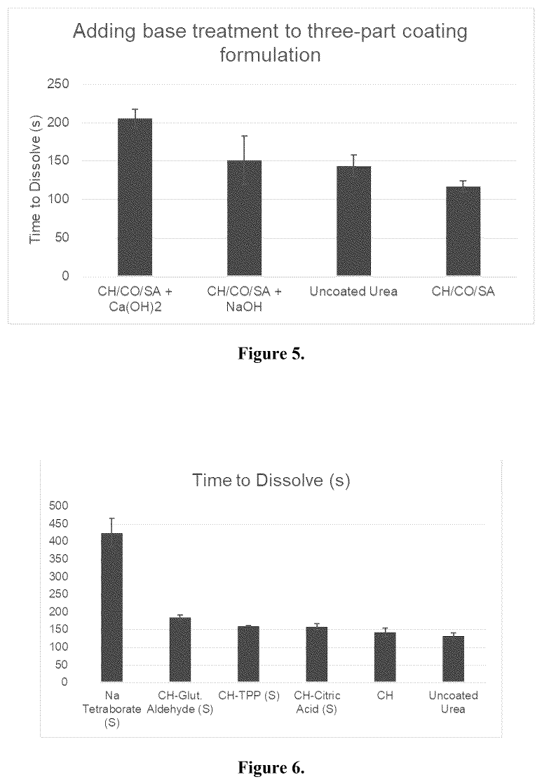

The base treatment was also performed on the three-part coating formulation-CH/CO/SA in a 50:32:12 ratio. FIG. 5 shows the effect of base treatment on persistence in water as measured by the time it takes the uncoated and coated pellets to dissolve. The Calcium hydroxide treatment significantly slowed the release (FIG. 5).

### Crosslinkers Layered on Top of the Chitosan Coating on the Urea

Pellets were coated with ~1% weight dry basis ratio of coating to urea pellet of the chitosan lactate (55 kDa, 6% in water). While still wet, the pellets were spray coated with 1.5 molar equivalents of crosslinker. Pellets were tested by placing them in water and visually inspected to see if they had dissolved. Once the pellet was dissolved, the urea would also have to be released. Likely the release is occurring before the pellet has visually dissolved in the water.

FIG. 6 shows effect of crosslinkers on persistence in water as measured by the time it takes the coated and uncoated pellets to dissolve. The method of application of the crosslinker is via spray for these examples and is labeled with an(S) to indicate this method. Sodium Tetraborate reduced the release of urea compared to chitosan alone, so additional crosslinkers were tested.

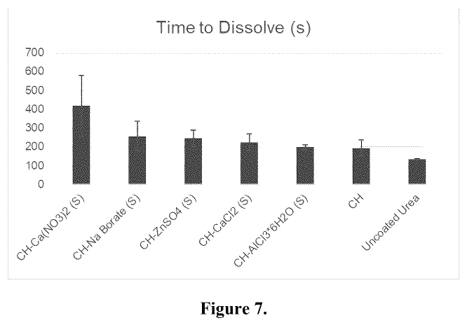

FIG. 7 shows the effect of crosslinkers on persistence in water as measured by the time it takes the uncoated and coated pellets to dissolve. The method of application of the crosslinker is via spray for these examples and is labeled with an(S) to indicate this method. Pellets coated with chitosan and then calcium nitrate were slower to dissolve (FIG. 7).

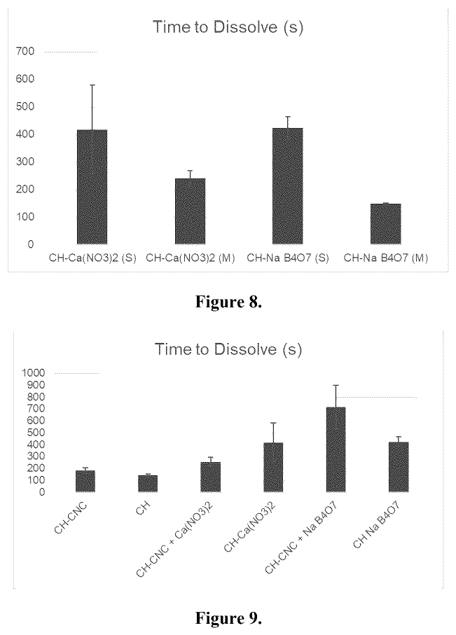

The method of applying the calcium nitrate and sodium tetraborate was also explored. We either mixed the crosslinker into the pellets, adding it all at once and stirring, or we sprayed the crosslinker solution onto the pellets. FIG. 8 shows the effect of method of application of crosslinkers on persistence in water as measured by the time it takes the coated and uncoated pellets to dissolve. Applying the crosslinker as a spray is indicated with an(S) in the figure, while mixing is indicated with an (M). The spray-applied crosslinkers performed better than the crosslinkers that were mixed with the pellets (FIG. 8).

### Cellulose Nanocrystals Added to Enhance Coating Properties

Cellulose nanocrystals were also applied as a potential crosslinker and physical reinforcement agent. The addition of cellulose nanocrystals improved release rates, particularly when used with sodium tetraborate.

Pellets were coated with ~1 weight % (dry coating: pellet) of the chitosan lactate (55 kDa, 6% in water). While still wet, the pellets were spray coated with 1.5 molar equivalents of crosslinker. Pellets were tested by placing in water and visually inspected to see if they had dissolved. Once the pellet was dissolved, the urea would also have to be released. Likely the release is occurring before the pellet has visually dissolved in the water.

FIG. 9 shows the effect of addition of cellulose nanocrystals to increase persistence of coating in water as measured by the time it takes the coated pellets to dissolve. Cellulose nanocrystals were also tested in the formulation with the addition of crosslinkers calcium nitrate and sodium tetraborate.

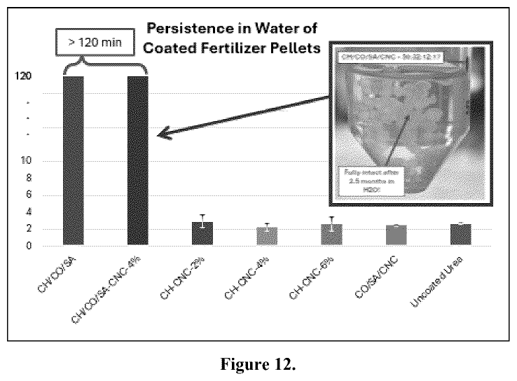

Further testing of cellulose was done with the three-part formulation (CH/CO/SA in a 50:32:12 ratio), wherein the formulation was a weight ratio of 50:32:12:17 (CH/CO/SA/CNC). FIG. 12 shows persistence in water of CH/CO/SA/CNC coating as measured by the time it takes the coated pellets to dissolve. The CH/CO/SA formulation with and without cellulose addition was tested. The CO/SA/CNC formulation (with no chitosan) was also tested and showed very limited persistence in water. The four-part formulation when applied as a coating led to visible persistence in water even after 2 hours (FIG. 12).

An additional image is included in FIG. 12 of the CH/CO/SA/CNC coated pellets after 2.5 months submerged in water to give a qualitative indication of the persistence of the coating in water over longer timeframes. Pictures of pellets with and without CNC are shown compared to a commercial urea pellet (ESN) which is coated with plastic.

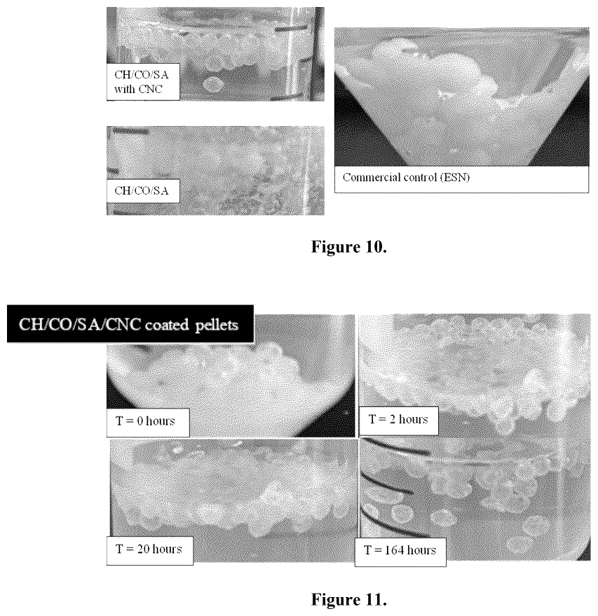

FIG. 10 shows images of CH/CO/SA and CH/CO/SA/CNC coated pellets compared to commercial controls after 2 hours. The pellets with CNC are still intact (similar to the commercial control shown), while the pellets without CNC have started to disintegrate in the water. FIG. 11 shows images of the persistence of CH/CO/SA/CNC coated pellets over time at 0 hours, 2 hours, 20 hours, and 164 hours. The pellets visibly remain even after 164 hours (1 week) (FIG. 11).

Chitosan is an important part of the formulation. Without chitosan in the coating, even with CNC, the time to dissolve is 147 s (Standard error of mean=4.62 s) while the coating with chitosan remains for the duration of the experiment (FIG. 12).

Chitosan and cellulose without either castor oil or stearic acid were soluble within 5 minutes, regardless of the concentration of cellulose (2 to 6 weight %), as were the coatings without chitosan (castor oil, stearic acid, and cellulose only) (FIG. 12). The CH/CO/SA/CNC coating remains intact in water for over 2.5 months (FIG. 12).

### Bilayer of Biopolymer and Chitosan-Based Coating Formulation

Polybutylene succinate (PBS) and poly(b-benzyl L-aspartate (PBLA) in a 7:3 ratio were dissolved in chloroform at 5% w/v and the solution was added to a rotating drum of urea pellets by slow addition (approximately 14.5% w/w coating/pellets over 4 hours).

Polyhydroxybutyrate-co-hydroxyhexanote (PHBH, a copolymer of 3-hydroxybutyrate and 3-hydroxyhexanoatewas dissolved in chloroform at 5% w/v and sprayed onto urea pellets while the pellets were tumbling in a rotating drum. Chloroform-soluble dye was added for easier visualization of the coating, hence the orange color of the pellets. Coating thickness was 17 weight percent of coated pellets.

CH/CO/SA and CH/CO/SA/CNC formulations were added on top of the PBS/PBLA or PHA-coated pellets at 3 weight %. These pellets were then tested for their persistence in water. A single pellet was submerged in 200 μL of water and visually checked to see at what time point it dissolved. Time points that were run: 10, 20, 34, 55, 102, 134, 175, 262, 1552, and 1887 (~31 hours). An additional long-term time point was added at 99 hours (4 days).

TABLE 10

| | rep 1 | rep 2 | rep 3 |
|---|---|---|---|
| PBS/PDLA + CH/CO/SA | >99 hrs | <10 min | >99 hrs |
| PBS/PDLA + CH/CO/SA/CNC | >99 hrs | <10 min | >99 hrs |
| PHA + CH/CO/SA | >99 hrs | >99 hrs | >99 hrs |
| PHA + CH/CO/SA/CNC | >99 hrs | >99 hrs | >99 hrs |
| CH/CO/SA | >99 hrs | >99 hrs | >99 hrs |

The majority of the coatings persisted in water after 4 days (Table 10). One of the three replicates for the PBS/PDLA+CH/CO/SA and PBS/PDLA+CH/CO/SA/CNC coated pellets did dissolve before the first time point. This is attributed to cracking of the coating due to the brittle nature of the PBS/PDLA coating. The PHA-based coating performed well with both the CH/CO/SA coating and the CH/CO/SA/CNC coating, lasting the length of the experiment with no obvious compromise of the integrity of the coating. The PHA coating is compatible with the chitosan-based formulation, leading to increased persistence in water, which contributes to slower release kinetics.

### Neutralized Chitosan-Urea Composite Pellets

Chitosan lactate (6% in water) and urea powder were mixed together in a dry ratio of 1:0, 2:1, 1:1, 1:2, and 1:3 of chitosan: urea. This solution was then added as a drop to 1M sodium hydroxide solution to neutralize the drops. The sodium hydroxide was dissolved in water, anhydrous ethanol, or an anhydrous ethanol solution saturated with urea. The addition of urea to the ethanol solvent was used to decrease the leaching of the urea into the solvent. The pellets were then dried for 12 to 72 hours in ambient humidity and room temperature.

Pellets created using this method were insoluble in water at long time scales, the longest of which tested was 3 months with no visual dissolving in water.

### Biodegradation of Coating in Home Compost and Marine Degradation Conditions

Three-part coating formulation-Chitosan lactate, Castor Oil, Stearic acid—was tested in marine conditions (Berkeley Marina water) using Pasco CO₂ sensors, wherein the carbon from the samples is being converted to carbon dioxide by the microbes naturally found in local marine water.

TABLE 11
Solid components of coating and their associated carbon content.

| COMPONENT | MASS (g) | CARBON CONTENT (%) |
|---|---|---|
| CHITOSAN LACTATE | 0.32 | 40.08 |
| CASTOR OIL | 3.41 | 72.37 |
| STEARIC ACID | 1.28 | 75.93 |
| FORMULATION | 5.01 | 71.23 |

TABLE 12
Calculation of respiration potential of the coating sample based
on the carbon content for biodegradation study run in triplicate.

| | | | CARBON | CARBON | | | |
|---|---|---|---|---|---|---|---|
| | MASS | MASS | CONTENT | CONTENT | CO₂ | CO₂ | MAX UL CO₂ |
| REP | (MG) | (G) | (WEIGHT %) | (g) | (g) | (L) | POSSIBLE |
| 1 | 75.07 | 0.07507 | 71.23 | 0.0535 | 0.1961 | 0.1091 | 109068 |
| 2 | 75.52 | 0.07552 | 71.23 | 0.0538 | 0.1972 | 0.1097 | 109722 |

The carbon content was calculated based on the carbon content of each component and the solid weight percent of each component in the formulation (Table 11). The chemical formula of glucosamine was used for the chitosan component as it is the monomer of chitosan. For castor oil, ricinoleic acid (major component at ~ 90%) was used to calculate the carbon content. The carbon percentage was then used to calculate the maximum microliters of CO₂ which could be produced (Table 12).

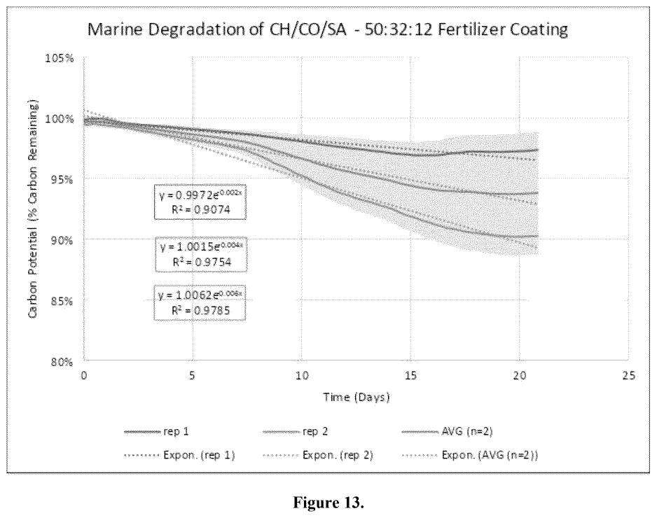

FIG. 13 shows marine degradation of CH/CO/SA-50:32:12 fertilizer coating for each replicate of the sample as well as the average. The error bars represent +/− one standard deviation. The single exponential fits for each replicate and the average are displayed as well.

The average biodegradation rate of the formulation is 3.67E-3 days⁻¹ which corresponds to a half-life of 280 days for a single exponential fit. The measured half-lives range from ~ 120 to 440 days (Table 13).

TABLE 13
Analysis of degradation of CH/CO/SA formulation, including
max conversion as well as the single exponential
fits used to determine rate and half-life.

| | MAX CONVERSION | | RATE | HALF-LIFE |
|---|---|---|---|---|
| REP | (%) | R² | (K, DAYS⁻¹) | (DAYS) |
| 1 | 3.14% | 0.909 | 1.58E−03 | 439 |
| 2 | 9.85% | 0.978 | 5.75E−03 | 121 |
| AVG | 6.50% | 0.944 | 3.67E−03 | 280 |
| STDEV | 4.75% | 0.049 | 2.95E−03 | 225 |

Four-part coating formulation-Chitosan lactate Schiff-base with Cuminaldehyde, Tung Oil, Glyceryl monolaurate—was tested in home compost conditions using an automated respirometer system (Microoxymax, Columbus Instruments, Columbus, OH, USA), wherein the carbon from the samples is being converted to carbon dioxide by the microbes naturally found in compost at 25° C.

The carbon content of the four-part formulation was calculated based on a weighted average of the carbon content of the components and their mass in the formulation (Table 14). For tung oil, eleostearic acid (major component at ~82%) was used to calculate the carbon content. Cuminaldehyde was added in a 1:1 molar ratio to the chitosan lactate to form the Schiff base.

TABLE 14
Solid components of four-part coating
and their associated carbon content.

| COMPONENT | MASS (g) | CARBON CONTENT (%) |
|---|---|---|
| CHITOSAN LACTATE | 0.60 | 40.08 |
| TUNG OIL | 10.01 | 77.58 |
| GLYCERYL MONOLAURATE | 1.19 | 65.60 |
| CUMINALDEHYDE | 0.50 | 80.97 |
| FORMULATION | 12.30 | 74.73 |

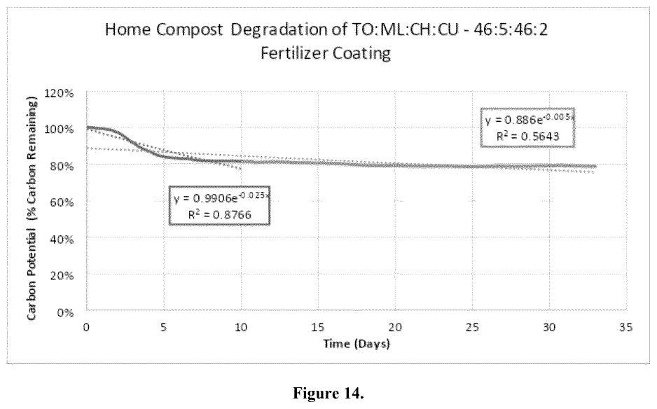

FIG. 14 shows biodegradation of TO:ML:CH:CU-46:5:46:2 weight ratio coating formulation in home compost conditions at 25° C. Single exponential fit shown for full dataset as well as dataset truncated to 10 days.

The degradation rate of the four-part formulation was 4.92E-3 days⁻¹ which corresponds to a half-life of 141 days for a single exponential fit. However, the degradation levels off around 10 days, so a 10-day initial fit can also be used to determine how well the coating degrades. For the initial 10 days of the degradation, the rate of degradation was 2.48E-2 days⁻¹ which corresponds to a half-life of 28 days. The rates of degradation and the extrapolated half-life for both the full dataset and the dataset truncated to the initial 10 days are shown in Table 15.

TABLE 15
Results of single exponential fit for four-part formulation in soil.

| | MAX | | | |
|---|---|---|---|---|
| | CONVERSION | | RATE | HALF-LIFE |
| FIT | (%) | R² | (K, DAYS⁻¹) | (DAYS) |
| FULL FIT | 21.7% | 0.558 | 4.92E−03 | 141 |
| INITIAL | 19.7% | 0.886 | 2.48E−02 | 28 |
| 10-DAY FIT | | | | |

Chitosan is a biopolymer that is known to degrade in marine and compost conditions (see ACS Omega 2025 10 (39), 45220-45231 incorporated herein by reference). The waxes and oils that make up the rest of the formulation are found in nature and so are assumed to be nonhazardous to the environment, if not degradable as well.

It is important to note that in a sealed container, the biodegradation of the samples can slow down to a point where the respiration is in equilibrium. Thus, the degradation rates represent a lower bound for the time it takes the sample to degrade and could degrade faster in an environment with less limited resources, as in nature.

Exemplified embodiments of modified chitosan Schiff bases (Figures below) and reductive amination products are depicted below.

### Preparation

Chitosan Schiff base. Chitosan (70 g of a 6% chitosan lactic acid solution) was diluted with ethanol (70 mL) containing 1 molar equivalent of aldehyde relative to glucosamine monomer. The reaction mixture was stirred at room temperature for 1 h and stored at room temperature in a 50 mL Falcon tube.

Reductive amination of Chitosan Schiff base. NaBH₃CN (1.5 molar equivalent relative to glucosamine monomer) was added to the chitosan-Schiff base solution in a glass beaker. The solution was allowed to stir at room temperature for 24 h, followed by adjusting the pH to >8 with 1M aqueous NaOH. The resulting precipitate was isolated via vacuum filtration.

### General Reaction Scheme for Chitosan Schiff Bases and Reductive Amination Products

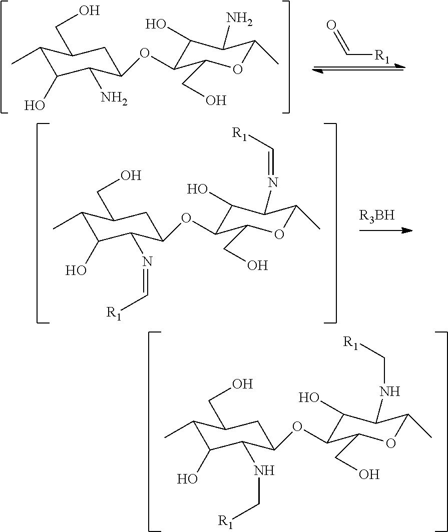

### Chitosan Schiff-Base Complexes

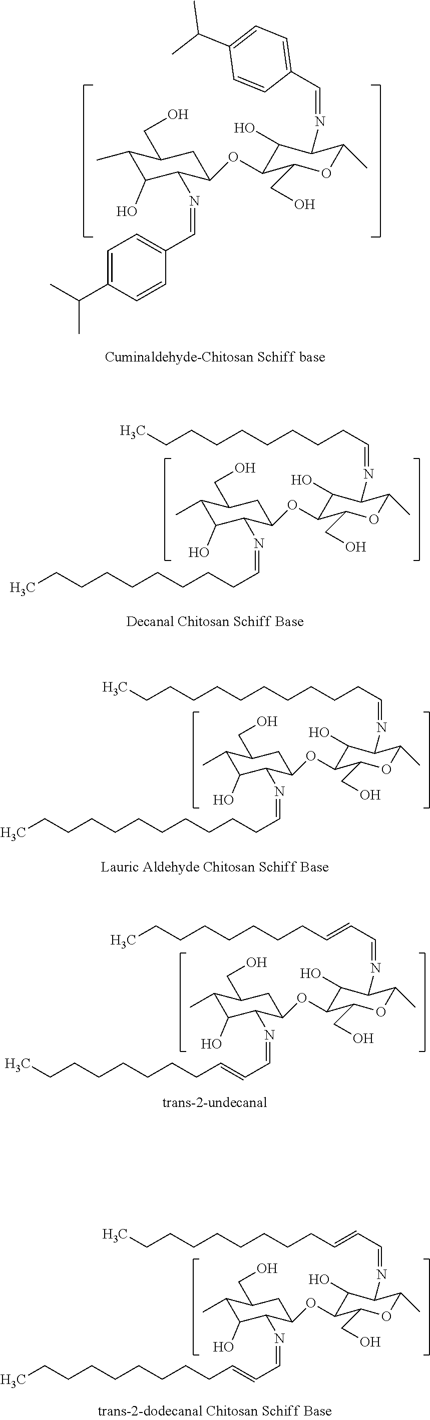

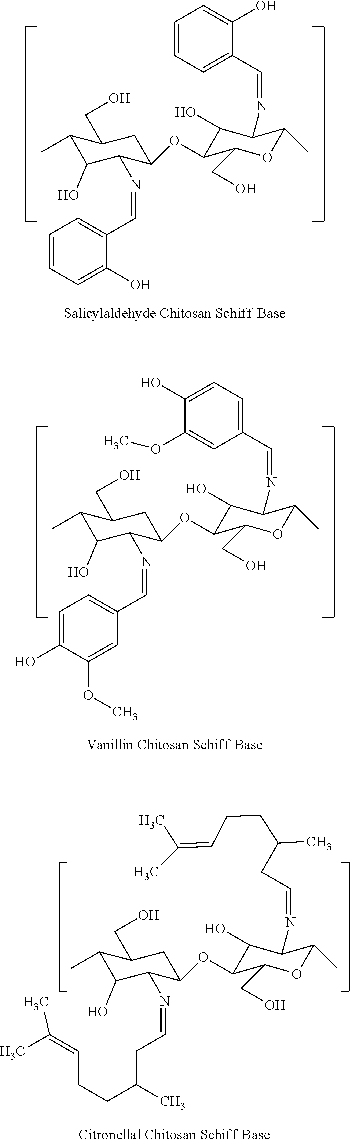

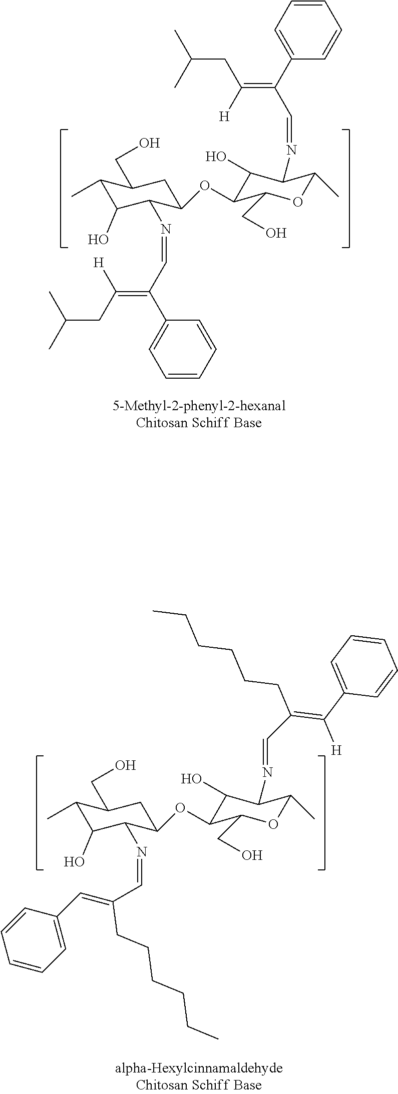

### Chitosan Schiff-Base Reductive Amination Products

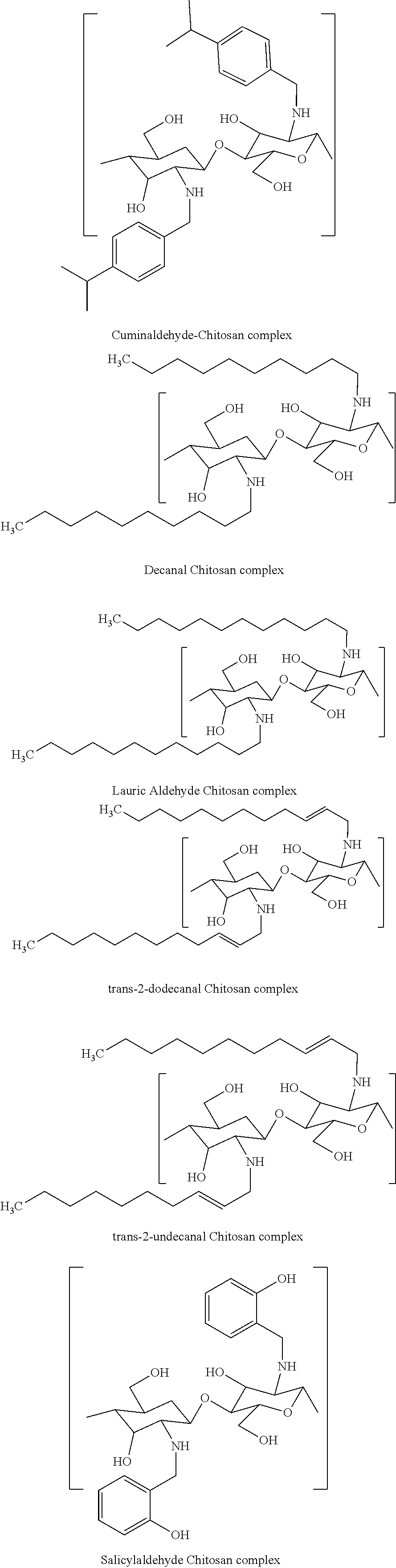

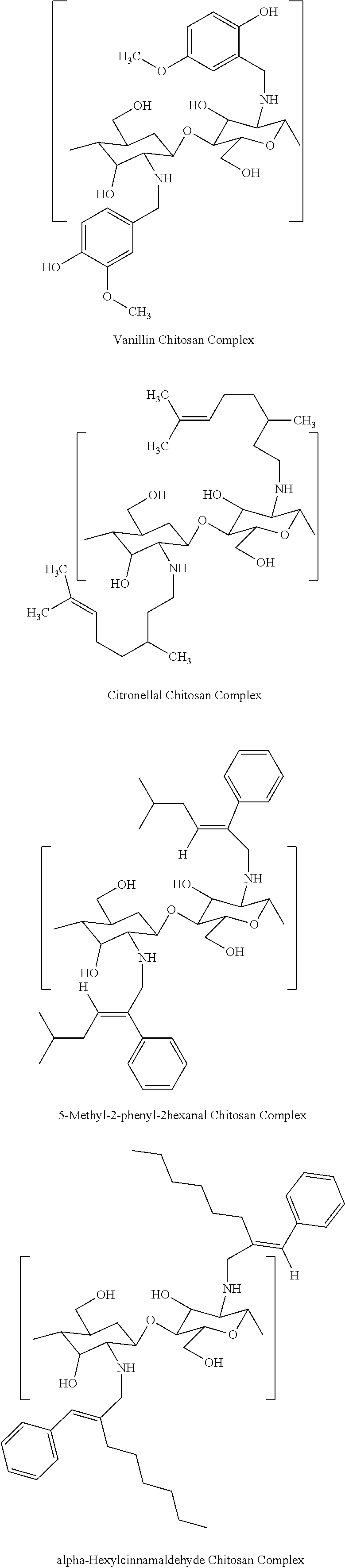

In one embodiment a composition is described comprising, one or more polysaccharides, one or more waxes and an one or more oils.

In one embodiment of the above composition, the polysaccharide is chitosan.

In one embodiment of the above composition, the polysaccharide is a chitosan Schiff-base.

In one embodiment of the above composition, the polysaccharide is a chitosan Schiff-base reductive amination product.

In one embodiment of the above composition, the wax comprises one or more compounds selected from capric acid, lauric acid, myristic acid, palmitic acid, stearic acid, polyhydroxy stearic acid, arachidic acid, glyceryl monocaprate, glyceryl monolaurate, glyceryl monomyristate, glyceryl monopalmitate, glyceryl monostearate, or mixtures thereof.

In one embodiment of the above composition, the wax can be derived from natural sources such as bees wax, carnauba, candelilla, shea butter, or mixtures thereof.

In one embodiment of the above composition, the oil comprises one or more compounds selected from selected from caprylic acid, palmitoleic acid, oleic acid, caproic acid, linoleic acid, linolenic acid, arachidonic acid, eicosapentaenoic acid, docosahexaenoic acid, or mixtures thereof.

In one embodiment of the above composition, the oil is derived from a natural source selected from castor oil, tung oil, canola oil, corn oil, sesame oil, or mixtures thereof.

In one embodiment of the above composition is used as a coating, composite, or intercalated on a cube, pellet, granules, tablet.

In one embodiment of the above composition, the coating thickness is between about 10 and 100 microns.

In one embodiment of the above composition, the weight ratio of coating to core of a cube, pellet, granules, tablet is between about 0.1 and 10%.

In one embodiment of the above composition, the weight ratio of coating to core of a cube, pellet, granules, tablet of fertilizer exemplified by urea is between about 0.1 and 10%.

In one embodiment of the above composition, caking percentage of a coated granules is between 0 and 99%.

In one embodiment of the above composition, caking tendency of a coated granules is between 0 and 60%.

In one embodiment of the above composition, moisture gain of a coated granules is between 0 and 12%.

In one embodiment of the above composition, dust-off of a coated granules is about 1% or less.

In one embodiment of the above composition, the polysaccharide is chitosan, the oil is castor oil, and the wax is stearic acid which are in about 50:32:12 weight ratio respectively.

In one embodiment of the above composition, it is used as coating on a fertilizer particle.

In one embodiment of the above composition, the fertilizer is urea.

In one embodiment of the above composition, the chitosan used is chitosan acetate, chitosan lactate, chitosan malate, chitosan acetate low molecular weight, chitosan lactate low molecular weight, chitosan malate low molecular weight, chitosan acetate medium molecular weight, chitosan lactate medium molecular weight or chitosan malate medium molecular weight or mixtures thereof.

In one embodiment of the above composition, it has an average biodegradation rate which corresponds to a half-life of 120 to 440 days in soil at 25° C. with moisture weight content of 10-90%.

In one embodiment of the above composition, it has an average biodegradation rate is about 3.67E-3 days⁻¹ which corresponds to a half-life of 280 days.

In one embodiment, a method of using a composition comprising a polysaccharide, a wax and an oil as coating or intercalated on a cube, pellet, granules, or tablet.

In one embodiment of the above method, the polysaccharide is a chitosan selected from chitosan acetate, chitosan lactate, chitosan malate, chitosan acetate low molecular weight, chitosan lactate low molecular weight, chitosan malate low molecular weight, chitosan acetate medium molecular weight, chitosan lactate medium molecular weight or chitosan malate medium molecular weight or mixtures thereof.

In one embodiment of the above method, the polysaccharide is chitosan, the oil is castor oil, and the wax is stearic acid.

In one embodiment of the above method, the chitosan, the castor oil, and stearic acid are in about 50:32:12 weight ratio respectively with the chitosan being 6% chitosan lactate in water.

In one embodiment of the above method, the granule is a fertilizer granule.

In one embodiment of the above method, the fertilizer granule coating is biodegradable with a half-life of 120 to 440 days.

In one embodiment of the above method, the fertilizer granule coating is biodegradable with a half-life of about 280 days.

In one embodiment, a composition is described with at least one ionic polysaccharide, at least one nonionic biopolymer, a wax and an oil.

In one embodiment of the above composition, the nonionic biopolymer is cellulose or derivative thereof selected from the group consisting of cellulose acetate, hydroxypropyl methylcellulose, carboxymethyl cellulose, methyl cellulose, ethyl cellulose or mixtures thereof.

In one embodiment of the above composition, the nonionic biopolymer is a bio-polyester or natural rubber containing polyisoprene, wherein said polyester is selected from one or more of polyhydroxyalkanoate, polyglycolic acid, polylactic acid, polybutylene succinate, polybutylene adipate terephthalate, polycaprolactone.

In one embodiment of the above composition, the the chitosan and polyester or natural rubber containing polyisoprene are applied separately to form a bilayer coating.

In one embodiment of the above composition, it has been treated with a neutralizing base, wherein the base is a carbonate, bicarbonate or hydroxide, selected from one or more of sodium carbonate, potassium carbonate, calcium carbonate, magnesium carbonate, sodium bicarbonate, potassium bicarbonate, sodium hydroxide, potassium hydroxide, calcium hydroxide, magnesium hydroxide.

In one embodiment of the above composition, the neutralizing base is applied as a solid powder onto composition of claim 1.

In one embodiment of the above composition, the neutralizing base is applied as a water-based solution onto composition of claim 1.

We claim:

1. A coating composition comprising:
one or more polysaccharides, one or more waxes and one or more oils.

2. The composition of claim 1 wherein the polysaccharide is chitosan.

3. The composition of claim 1 wherein the polysaccharide is a chitosan Schiff-base.

4. The composition of claim 1 wherein the polysaccharide is a chitosan Schiff-base reductive amination product.

5. The composition of claim 1 wherein the wax comprises one or more compounds selected from capric acid, lauric acid, myristic acid, palmitic acid, stearic acid, polyhydroxy stearic acid, arachidic acid, glyceryl monocaprate, glyceryl monolaurate, glyceryl monomyristate, glyceryl monopalmitate, glyceryl monostearate, or mixtures thereof.

6. The composition of claim 1 wherein the wax can be derived from natural sources such as bees wax, carnauba, candelilla, shea butter, or mixtures thereof.

7. The composition of claim 1 wherein the oil comprises one or more compounds selected from selected from caprylic acid, palmitoleic acid, oleic acid, caproic acid, linoleic acid, linolenic acid, arachidonic acid, eicosapentaenoic acid, docosahexaenoic acid, or mixtures thereof.

8. The composition of claim 1 wherein the oil is derived from a natural source selected from castor oil, tung oil, canola oil, corn oil, sesame oil, or mixtures thereof.

9. The composition of claim 1 as a coating, composite, or intercalated on a cube, pellet, granules or tablet.

10. The composition of claim 9 wherein the coating thickness is between about 10 and 100 microns.

11. The composition of claim 9 wherein weight ratio of coating to core of a cube, pellet, granules or tablet is between about 0.1 and 10%.

12. The composition of claim 9 wherein a caking percentage of a coated granules is between 0 and 99%.

13. The composition of claim 9 wherein a caking tendency of a coated granules is between 0 and 60%.

14. The composition of claim 9 wherein a moisture gain of a coated granules is between 0 and 12%.

15. The composition of claim 9 wherein a dust-off of a coated granule is about 1% or less.

16. The composition of claim 1 wherein the polysaccharide is chitosan, the oil is castor oil, and the wax is stearic acid which are in about 50:32:12 weight ratio respectively.

17. The composition of claim 1 as coating on a fertilizer particle.

18. The composition of claim 17 wherein the fertilizer is urea.

19. The composition of claim 1 wherein the chitosan used is chitosan acetate, chitosan lactate, chitosan malate, chitosan acetate low molecular weight, chitosan lactate low molecular weight, chitosan malate low molecular weight, chitosan acetate medium molecular weight, chitosan lactate medium molecular weight or chitosan malate medium molecular weight or mixtures thereof.

20. The composition of claim 1 with an average biodegradation rate which corresponds to a half-life of 120 to 440 days in soil at 25° C. with moisture weight content of 10-90%.

21. The composition of claim 1 wherein an average biodegradation rate is about 3.67E-3 days⁻¹ which corresponds to a half-life of 280 days.

22. A method of using a composition comprising a polysaccharide, a wax and an oil as coating or intercalated on a cube, pellet, granules, or tablet.

23. The method of claim 22 wherein the polysaccharide is chitosan selected from chitosan acetate, chitosan lactate, chitosan malate, chitosan acetate low molecular weight, chitosan lactate low molecular weight, chitosan malate low molecular weight, chitosan acetate medium molecular weight, chitosan lactate medium molecular weight or chitosan malate medium molecular weight or mixtures thereof.

24. The method of claim 22 wherein the polysaccharide is chitosan, the oil is castor oil, and the wax is stearic acid.

25. The method of claim 22 wherein the chitosan, the castor oil, and stearic acid are in about 50:32:12 weight ratio respectively with the chitosan being 6% chitosan lactate in water.

26. The method of claim 22 wherein the granule is a fertilizer granule.

27. The method of claim 26 wherein the fertilizer granule coating is biodegradable with a half-life of 120 to 440 days.

28. The method of claim 26 wherein the fertilizer granule coating is biodegradable with a half-life of about 280 days.

29. A coating composition comprising:
at least one ionic polysaccharide, at least one nonionic biopolymer, a wax and an oil.

30. The composition of claim 29 wherein said nonionic biopolymer is cellulose or derivative thereof selected from the group consisting of cellulose acetate, hydroxypropyl methylcellulose, carboxymethyl cellulose, methyl cellulose, ethyl cellulose or mixtures thereof.

31. The composition of claim 29 wherein said nonionic biopolymer is a biopolyester or natural rubber containing polyisoprene, wherein said polyester is selected from one or more of polyhydroxyalkanoate, polyglycolic acid, polylactic acid, polybutylene succinate, polybutylene adipate terephthalate, polycaprolactone.

32. The composition of claim 29 wherein the chitosan and polyester or natural rubber containing polyisoprene are applied separately to form a bilayer coating.

33. The composition of claim 32 that has been treated with a neutralizing base, wherein the base is a carbonate, bicarbonate or hydroxide, selected from one or more of sodium carbonate, potassium carbonate, calcium carbonate, magnesium carbonate, sodium bicarbonate, potassium bicarbonate, sodium hydroxide, potassium hydroxide, calcium hydroxide, magnesium hydroxide.

34. The neutralization base of claim 32 wherein the base is applied as a solid powder onto composition of claim 1.

35. The neutralization base of claim 32 wherein the base is applied as a water-based solution onto composition of claim 1.
